(19) United States
(12) Patent Application Publication
(10) Pub. No.: US 2024/0251790 A1
(43) Pub. Date: Aug. 1, 2024

(54) ANTIMICROBIAL CONTROL FOR GRAINS OR SEEDS DURING MALTING

(71) Applicant: Evonik Operations GmbH, Essen (DE)

(72) Inventors: Weidong AN, Williamsville, NY (US); Elena Pisanova, Amherst, NY (US); Coryn Mittiga, Tonawanda, NY (US); John M. Rovison, Sanborn, NY (US); John Wallace, Audubon, NJ (US)

(73) Assignee: Evonik Operations GmbH, Essen (DE)

(21) Appl. No.: 18/559,752

(22) PCT Filed: Apr. 29, 2022
(86) PCT No.: PCT/EP2022/061434

§ 371 Date: Nov. 8, 2023

Related U.S. Application Data
(60) Provisional application No. 63/186,606, filed on May 10, 2021.

(51) Int. Cl. A01N 37/02; A01N 59/00; A01P 1/00; A23B 9/26; C12C 1/02; C12C 1/027; C12C 1/16

(52) U.S. Cl. CPC A01N 37/02; A01N 59/00; A01P 1/00; A23B 9/26; C12C 1/02; C12C 1/027; C12C 1/16

(57) ABSTRACT

Compositions and methods can be used to reduce the population of microorganisms present during the processing of grains and seeds. More specifically, microorganism levels are reduced in grains and seeds being malted by contacting the grains and seeds with a sanitizing solution that contains a peroxyacid and hydrogen peroxide.

### FIELD OF THE INVENTION

The present invention concerns the use of antimicrobial agents in the processing of grains for use in food products and beverages.

### BACKGROUND OF THE INVENTION

Barley, rice, wheat, oats and other grains or seeds often undergo a malting process before they are used in the production of foods and beverages. Malting has three sequential steps: steeping, germinating and kilning. Many procedures also include a prewash step prior to steeping. In the steeping step, grains or seeds are immersed in a large volume of water and incubated, typically for 1-3 days. During this time, they absorb water and enzymes needed for germination are activated. The seeds or grains are then typically transferred to germination bins where they are maintained in a moist, warm atmosphere for several days to allow rootlets to sprout. Finally, the seeds are transferred to a kiln and dried to reduce their moisture content to about 3-8%. Kilning may last for 12-48 hours, although longer periods may sometimes be used.

Harvested grains and seeds typically harbor a number of harmful microorganisms, including toxigenic filamentous fungi species of Alternaria, Aspergillus, Fusarium, and Penicillium. The temperature and high humidity used during germination creates an environment favorable to the activation of the spores of these fungi and promotes the production of mycotoxins. In this regard, Fusarium species are of the most concern due to the prevalence of Fusarium Head Blight (FHB) disease in crops. Fusarium infection also negatively impacts malt quality.

Several physical methods have been tried for reducing microbial contamination, such as thermal or vibrational cleaning of the grains. Chemical agents such as gaseous ozone, chlorine dioxide, and sodium hypochlorite have also been tried (1, 6, 8). These physical and chemical procedures were used mostly prior to steeping and, in some cases, helped to inactivate the microbial population.

A few attempts have been described recently where decontamination procedures were performed not before, but rather during the malting process. For example, ozone treatment has been applied during steeping via a submerged gas sparger (8) and chlorine dioxide has been used during several stages of malting (6). Another approach is to control the development of the microflora during malt production by promoting the growth of desirable microbial cultures, selected either as biocontrol agents inhibiting mycotoxin-producing molds or as starter cultures actively contributing to malt modification (7).

However, an effective method for reducing the level of fungal contamination and concomitant toxins has yet to be developed. The suggested methods generally lack economic feasibility and sometimes produce by-products that are difficult to remove. Thus, there remains a continuing need for a means to effectively reduce the presence of microbial contaminants and toxins in the processing of grains and seeds. Preferably, such treatments would also be environmentally safe.

### SUMMARY OF THE INVENTION

Malting of grains and seeds has three sequentially performed steps: steeping, germination and kilning. In its first aspect, the invention is directed to a method of treating harvested grain or seeds to reduce the presence of harmful microorganisms during malting by performing a decontamination procedure. Specifically, grains or seeds are contacted with a sanitizing solution comprising a peroxyacid and hydrogen peroxide. The sanitizing solution has 250-5000 ppm peroxyacid, preferably 250-2000 ppm; 250-1000 ppm; or 250-750 ppm, and contact between the grains or seeds and the sanitizing solution is maintained for a period sufficient to reduce the total microbial count (APC) and/or the yeast and mold count (YM) by at least 90%, preferably at least 95 or 99%, compared to the same grains or seeds prior to contact with sanitizing solution. The grains or seeds can be treated after steeping but before germination; and/or after germination but before kilning; and/or after kilning; with the proviso that the grain or seeds are not contacted with sanitizing solution prior to steeping.

After being maintained in contact with sanitizing solution, grains or seeds may, optionally, be washed to remove the sanitizing solution and/or the sanitizing solution may be treated with a reducing agent to neutralize the hydrogen peroxide. Low pH values appear to generally work the best for purposes of decontamination. Thus, the procedure should typically be performed at a pH below 7 and preferably in the range of 3-5. To minimize potential adverse effects of this treatment on germination, the time of contact should not last more than 10 minutes. For example, contact may be for 3-10 minutes or 0.5-3 minutes. The concentration of peroxyacid should generally be kept at 250-2000 ppm, preferably at 250-1000 ppm or 250-750 ppm.

Adverse effects that the decontamination may have on germination can be largely avoided by using a pH above 7, e.g., pH 8-12 or 8-11. To be highly effective, treatment at the higher pH 8-11 should last for at least 10 minutes and not more than 40 or 60 minutes. For example, a range of 1-40 minutes or 5-30 minutes can be used. The sanitizing solution should have a peroxyacid to peroxide ratio in the range of 5.0 to 0.2.

The methods of decontamination can be used on grains or seeds from barley, wheat, rye, millet, corn (maize), rice, or oats, with the most preferred being barley. Sanitizing solution can be applied by washing or spraying the grains or seeds, e.g., at a volume of 0.05 liters to 5.0 liters per kilogram of dry grain. Although many of the methods and compositions described herein refer to the use of peracetic acid (PAA) as an antimicrobial agent, other peroxyacids may be used in the place of PAA or together with PAA. Other peroxyacids that can be used include percitric acid, perlactic acid, perpropionic acid, peroxalic acid, permalic acid, permalonic acid, persuccinic acid, perglutaric acid, peradipic acid, permaleic acid, perfumaric acid and mixtures thereof. The most preferred of these are peracetic acid and percitric acid. Microorganisms in the grain or seeds that can be reduced as a result of the decontamination methods described herein include mold, yeast, bacteria and fungi. Of particular interest is the reduction of Fusarium, Alternaria, Mucor, Penicillium, or Aspergillus.

In addition to contacting grains or seeds with sanitizing solution after steeping but before germination; and/or after germination but before kilning; and/or after kilning; the grains or seeds may be germinated, at least in part, in the presence of a sanitizing solution comprising a peroxyacid and hydrogen peroxide. For example, germination may take place by maintaining grains or seeds in a moist environment while in contact with sanitizing solution. The grains or seeds can be soaked in sanitizing solution, wrapped in material soaked in sanitizing solution, or exposed to a mist of sanitizing solution. Germination is typically carried out at a temperature of 5° C.-35° C. for a period of about 3 to 7 days.

The pH during the germination process may be kept at 3-5, in which case the time of contact should generally not last more than 10 minutes. For example, contact could be maintained for 3-10 minutes or for 0.5-3 minutes. Alternatively, germination can be carried out at a pH of between 8 and 11. Under these circumstances, contact may be maintained for a longer period, e.g. 1-60 minutes or 5-30 minutes. The concentration of peroxyacid may be maintained at between 250 and 5000 ppm during this time.

Finally, in addition to contacting grains or seeds with sanitizing solution after steeping but before germination; and/or after germination but before kilning; and/or after kilning; the grains or seeds can be contacted with sanitizing solution during at least part of the kilning process. Decontamination during kilning may be accomplished, for example, by applying sanitizing solution to grains or seeds within one minute of the start of kilning or by applying sanitizing solution as spray during kilning. Guidance provided above for applying sanitizing solution after germination but before kilning also generally applies to decontamination during kilning with respect contact times, pHs, concentrations, etc.

### BRIEF DESCRIPTION OF THE DRAWINGS

FIG. 1: FIG. 1 shows the effect of PAA on the fungal load of a malt.

### DEFINITIONS

Sanitizing solution: As used herein this term refers to a composition comprising a peroxyacid and hydrogen peroxide which can be used to reduce the number of microorganisms in a harvested grain or seed.

Malting: This refers to a process in which harvested grains and seeds are steeped, germinated and kilned. Often there is also prewash of grains or seeds prior to steeping. Malted grains and seeds are primarily used in making beer, ale and hard liquors.

Steeping: Steeping involves immersing grain or seeds in a large volume of water to form a steep mixture. The mixture is incubated, typically with one or more periods during which the water is removed, grains or seed are exposed to air and then re-immersed. The objective is to promote the absorption of water by the seeds or grains and to thereby activate enzymes that promote germination. Typically, steeping is performed in a large container, such as a vessel or vat, which may be equipped with mechanical stirring, agitation and/or aeration equipment. A wide variety of steeping protocols may be employed depending on the type of harvested grain to be malted, the harvested grain quality and kernel size, the steeping vessel configuration, the downstream application of the malted grain, and maltster preferences. Harvested grain may be steeped more than once and two or three steepings are common, often over a total period of 2-4 days. Where multiple steepings are performed, the grain may be rested or aerated between steepings.

Germinating: After the harvested grain or seeds are steeped, they are germinated. The germinating step may be performed at a temperature of about 5° C.-30° C. for a period of about 3 to 7 days. In some cases, germination also includes one or more transfers of the germinating grain from one germination box to another, spraying one or more times with water, separating the germinated grain from the aqueous solution, and optionally washing the germinated grain with water after the separating step. For example, the cereal grain may be filtered from the aqueous solution after the solution spraying step(s) and optionally washed with water.

Kilning: This is the final step in malting and involves heating the germinated seeds or grains to dry it and stop germination. Typically, this is done using dry convection heat and results in grain or seeds with a water content of about 5%. Kilning typically takes about 12-24 hours but much longer times may be used in some instances.

Peroxyacid: As used herein, a peroxyacid (or peracid) is a peroxy derivative of an organic carboxylic acid and is characterized by the presence of an acidic —OOH group.

### DETAILED DESCRIPTION OF THE INVENTION

In the present invention, sanitizing solutions containing peroxyacids and hydrogen peroxide (either generated from the peroxyacids reacting with water or added to solutions) are used at specific pHs (e.g., 3-5) to treat grains or seeds after steeping but before germination, after germination but before kilning or after kilning. This may be done by spraying the solution onto the grain or seeds or by briefly immersing the grains or seeds for a period typically of 0.5 minutes-1 hour or until a desired reduction in microorganisms is reached. A brief (<10 minute) decontamination procedure may be performed at a low pH (where the sanitation is most effective) and with relatively high concentrations of peroxyacids (250-2000 ppm, 250-1000 ppm 500-1000 ppm or 500-750 ppm). However, at a low pH, high peroxyacid concentrations and long contact times can sometimes have a negative effect on the mashing process (particularly with respect to germination). This problem can be largely avoided if decontamination is carried out at a higher pH (8-12, 8-11 or 8-10). Sanitizing solution may also be used after steeping and before germination, during germination, after germination and before kilning, during kilning or after kilning.

The object of the present invention is a method of treating harvested grain or seeds to reduce the presence of harmful microorganisms during a malting procedure, comprising performing a decontamination by contacting the grain or seeds with a sanitizing solution comprising a peroxyacid and hydrogen peroxide, wherein:
a) said malting procedure comprises sequentially performing a steeping step, a germination step and a kilning step;
b) said sanitizing solution comprises 250-5000 ppm peroxyacid;
c) contact between the grains or seeds and the sanitizing solution is maintained for a period sufficient to reduce the total microbial count (APC) of the grains or seeds and/or the yeast and mold count (YM) by at least 90% compared to the same grains or seeds prior to contact with sanitizing solution;
d) the grains or seeds are contacted with the sanitizing solution after steeping but before germination; and/or after germination but before kilning; and/or after kilning;
   and wherein the grains or seeds are not contacted with sanitizing solution prior to steeping.

Preferably, the seeds or grains are washed to remove the sanitizing solution and/or the sanitizing solution is treated with a reducing agent to neutralize the hydrogen peroxide after contacting the grain or seeds with sanitizing solution.

In a preferred embodiment the decontamination of the grains or seeds is carried out at a pH below 7, more preferably at a pH of 3-5.

Preferably, the contact between the grains or seeds and the sanitizing solution does not last more than 10 minutes, more preferably the contact lasts for 3-10 minutes.

In an alternative embodiment the contact between the grains or seeds and the sanitizing solution lasts for 0.5-3 minutes.

In a further alternative embodiment, the decontamination of the grains or seeds is carried out at a pH of 7 or higher, preferably at a pH of 8-11, more preferably at a pH of 8-10.

Preferably, the contact between the grains or seeds and the sanitizing solution does not last more than 60 minutes, more preferably not more than 40 minutes. Preferably, the contact between the grains or seeds and the sanitizing solution lasts for 1-40 minutes, more preferably for 5-30 minutes.

In a preferred embodiment the sanitizing solution has a peroxyacid to peroxide ratio in the range of 5.0 to 0.2.

Preferably, the grain or seeds are from barley, wheat, rye, millet, corn (maize), rice, or oats, most preferred from barley.

In a preferred embodiment the sanitizing solution is applied by washing or spraying the grains or seeds.

Preferably, the amount of sanitizing solution used for contacting the grain or seeds is 0.05 liters to 5.0 liters per kilogram of dry grain.

Preferably, the peroxyacid used in decontaminating grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid and mixtures thereof. Most preferred is the peroxyacid peracetic acid or percitric acid.

The microorganisms in the grain or seeds that are reduced as a result of decontamination by the claimed method can comprise a mold, yeast, or bacteria. In a further or alternative embodiment comprises the microorganisms in the grain or seeds that are reduced as a result of decontamination a fungus, for example a fungus selected from Fusarium, Alternaria, Mucor, Penicillium, or Aspergillus.

In a further developed embodiment the method comprises that in addition to contacting grains or seeds with sanitizing solution after steeping but before germination; and/or after germination but before kilning; and/or after kilning; the grains or seeds are germinated, at least in part, in the presence of a sanitizing solution comprising a peroxyacid and hydrogen peroxide. Especially, the germination comprises maintaining the grains or seeds in a moist environment while in contact with sanitizing solution.

Preferably, the germination comprises soaking the grains or seeds in sanitizing solution, wrapping the grains or seeds in material soaked in sanitizing solution, or exposing the seeds to a mist of sanitizing solution.

In a further developed embodiment it is preferred that the germination is carried out at a temperature of 5° C.-35° C. for a period of about 3 to 7 days.

Preferably the germination is carried out at a pH of between 3 and 5, wherein preferably contact between the grains or seeds and the sanitizing solution does not last more than 10 minutes, more preferred the contact lasts for 3-10 minutes.

Alternative contact between the grains or seeds and the sanitizing solution lasts preferably for 0.5-3 minutes.

Alternative the germination can be carried out at a pH of between 8 and 11, wherein preferably contact between the grains or seeds and sanitizing solution is maintained for 1-60 minutes of the germination process, more preferred contact between the grains or seeds and sanitizing solution is maintained for 5-30 minutes of the germination process.

Preferably in addition to contacting grains or seeds with sanitizing solution after steeping but before germination; and/or after germination but before kilning; and/or after kilning; the grains or seeds are contacted with sanitizing solution during at least part of the kilning process. Wherein the sanitizing solution is preferably applied to the grains or seeds within one minute of the start of kilning and especially as a spray during kilning.

### EXAMPLES

The following examples are intended to illustrate, but not limit the invention.

### Example 1: Treatment of Barley with Peracetic Acid after Steeping

Barley kernels were steeped for 24 hours in DI water at 20° C. To 40 grams of dry barley grains DI water was added at 2:1 ratio. Then compressed air was directed into the system providing continuous aeration. Air was supplied through a bubbler for a better distribution of air in the liquid. The system was shaken periodically to provide access of air to all the grains. After steeping, the grains were treated with peracetic acid (PAA) solutions. PAA solutions were made using PeroxyChem VigorOx® containing 15% of PAA and 10% of H₂O₂. VigorOx was diluted with DI water to obtain a required concentration of PAA. The pH of the solution was adjusted using 20% solution of Sodium Hydroxide in water.

The treatment was performed at 20° C. as follows: 100 ml of PAA solution at 500 ppm (unadjusted or adjusted to pH=9.0) were applied to 10.0 g of wet barley grains. Solutions with the grains were then shaken for 30 seconds and then the acid solution was neutralized by addition of 0.5 g sodium thiosulfate. The solutions were then used to evaluate effect of PAA treatment on total microbial count (APC), coliforms (ECC), and yeast and mold (YM). Control samples were treated with DI water.

Each sample was diluted serially into Butterfield's phosphate buffer, and the dilutions were plated on Petrifilm™ (3M, Minneapolis, MN) plates specific for different types of microorganisms. The plates were incubated for 48 hours at 35° C. for APC, and for 5 days at 25° C. for YM. For ECC, the incubation was done at 35° C. for 24 hours, then coliforms were counted, and incubation continued for an additional 24 hours at 35° C. Grown colonies on plates were counted and expressed in CFU/10 g barley grains for each treatment. The tests were done in duplicates. The results of the tests done with APC, ECC, and YM microorganisms are summarized in the Table 1.

TABLE 1
Reduction of microbial populations after
treatment steeped barley with PAA

| | APC | | ECC | | YM | |
|---|---|---|---|---|---|---|
| | | Log₁₀ | | Log₁₀ | | Log₁₀ |
| Treatment | Log₁₀ | Reduction | Log₁₀ | Reduction | Log₁₀ | Reduction |
| Control | 9.15 | n/a | 7.90 | n/a | 5.59 | n/a |
| PAA, pH = 3.1 | 6.99 | 2.16 | 5.99 | 1.91 | 3.84 | 1.75 |
| PAA, pH = 9.0 | 7.34 | 1.81 | 5.79 | 2.11 | 4.06 | 1.53 |

PAA treatment resulted in reduction in all microbial populations tested by 1.5-2.1 Log₁₀. pH adjustment did not reduce the antimicrobial effect of peroxyacid.

### Example 2: Treatment of Barley with Peracetic Acid after Germination

Steeping the barley grains was performed as described in Example 1. Wet steeped grains were then transferred into Petri dishes and placed between two wet paper towels for germination. The germination continued in a water bath at room temperature for 2 days.

10.0 grams of germinated grains were taken for each test. The treatment with PAA was performed as described in Example 1. The results of the tests done with APC, ECC, and YM microorganisms are summarized in Table 2.

TABLE 2
Reduction of microbial populations after
treatment of germinated barley with PAA

| | APC | | ECC | | YM | |
|---|---|---|---|---|---|---|
| | | Log₁₀ | | Log₁₀ | | Log₁₀ |
| Sample ID | Log₁₀ | Reduction | Log₁₀ | Reduction | Log₁₀ | Reduction |
| Control | 9.21 | n/a | 7.99 | n/a | 5.46 | n/a |
| PAA, pH = 3.1 | 7.23 | 1.98 | 6.83 | 1.16 | 3.60 | 1.86 |
| PAA, pH = 9.0 | 8.01 | 1.20 | 7.39 | 0.60 | 3.83 | 1.63 |

Unadjusted PAA provided 1-2 Log₁₀ reduction of all microorganisms. Adjustment to pH=9 slightly reduced its efficiency for ECC.

The results of the experiments in Examples 1 and 2 show that the antimicrobial treatment with PAA could be performed after steep and/or germination stage of the malting process.

### Example 3: Treatment of Barley with Peracetic Acid After Steeping and Germination

Two beakers were used for the experiments. In each beaker, 40 grams of dry barley grains were placed. DI water was added to the grains at 2:1 ratio. Steeping was performed as described in the Example 1. After the end of the steep time, water was decanted and then the grains in the first beaker were treated with 500 ppm PAA solution at 2:1 PAA/grains weight ratio for 10 minutes at 20° C. Then the PAA solution was decanted and samples of grains from both beakers were taken for the micro tests. The rest of the grains were returned into the two cylinders. Then DI water was added to maintain the ratio of liquid to grains at 2:1, and the aeration continued for two more days. On day 4, the grains in the first cylinder were divided into two parts, and one part was left as is, whereas the second half was treated with 500 ppm PAA solution at 2:1 PAA/grains weight ratio for 10 min at 20° C., as in the first treatment.

Then the micro tests were performed on all the samples. The results of the tests done with APC and ECC microorganisms are summarized in the Table 3.

TABLE 3
APC and ECC Reduction after treatment barley with PAA

| Test | Sample | APC | | ECC | |
|---|---|---|---|---|---|
| on the | treated | | Log₁₀ | | Log₁₀ |
| Day # | with PAA | Log₁₀ | Reduction | Log₁₀ | Reduction |
| 2 | Control | 8.14 | n/a | 4.36 | n/a |
| 2 | Once, day 2 | 3.84 | 4.30 | 0.00 | 4.36 |
| 4 | Control | 9.24 | n/a | 7.23 | n/a |
| 4 | Once, day 2 | 6.72 | 2.52 | 5.41 | 1.82 |
| 4 | Twice, days | 5.78 | 3.46 | 4.95 | 2.28 |
| | 2 and 4 | | | | |

As can be seen from the data, the treatment with PAA on the day 2 resulted in a significant reduction of microorganisms. However, by the day 4 the microbial population grew again, and the effect of the first treatment was reduced: APC and ECC showed 2.5 and 1.8 log₁₀ reduction respectively compared to control grains. An additional improvement was observed for the grains treated twice, on the days 2 and 4.

### Example 4: Effect of pH and Treatment Time on PAA Antimicrobial Efficiency

Barley grains were steeped and then treated with PAA at 500 ppm as described in Example 1. PAA solution was used unadjusted (pH=3.1) and adjusted with NaOH to pH=9.0. Treatment time was varied from 5 s to 10 min. Results are given in the Table 4.

TABLE 4
Reduction of microbial populations after treatment steeped barley with PAA

| | | | APC | | ECC | | YM | |
|---|---|---|---|---|---|---|---|---|
| PAA | Treatment | | | Log₁₀ | | Log₁₀ | | Log₁₀ |
| Treatment | time | | Log₁₀ | Reduction | Log₁₀ | Reduction | Log₁₀ | Reduction |
| Control | n/a | | 8.48 | n/a | 7.20 | n/a | 4.48 | n/a |
| Unadjusted | 5 | s | 8.19 | 0.29 | 4.60 | 2.60 | 2.95 | 1.53 |
| “—” | 30 | s | 6.54 | 1.93 | 2.60 | 4.60 | 0.00 | 4.48 |
| pH = 9 | 5 | s | 7.97 | 0.51 | 5.48 | 1.73 | 3.86 | 0.62 |
| 9 | 30 | s | 6.72 | 1.75 | 4.78 | 2.43 | 2.60 | 1.88 |
| 9 | 10 | min | 6.25 | 2.23 | 3.63 | 3.57 | 2.80 | 1.79 |

As can be seen from the data, the treatment with PAA for 30 s resulted in 2.0-4.5 Log₁₀ reduction of all microorganisms. Increasing the treatment time to 10 min did not give any additional advantage. pH adjustment to pH=9.0 made PAA somewhat less efficient; however, given sufficient time, PAA at higher pH is an active biocide providing 2-3 Log₁₀ reduction.

### Example 5: Effect of pH and Treatment Time on the Barley Germination

The grains treated with PAA as described in Example 4 were further tested for germination. After the treatment, the PAA solution was decanted and kernels were immediately transferred into Petri dishes and placed between two wet paper towels for germination tests. The treated kernels were not washed with water. The germination continued in a water bath at room temperature for 2 days. Germination was evaluated by the percentage of living kernels in a sample of barley. An average of two measurements for each test is shown in the Table 5.

TABLE 5
Germination of Barley treated with 500 ppm PAA

| Sample | Treatment with PAA | | | Germination |
|---|---|---|---|---|
| # | pH | Time | | % |
| 1 | 3.1 | 30 | s | 100 |
| 2 | 3.1 | 5 | min | 100 |
| 3 | 3.1 | 10 | min | 94 |
| 4 | 3.1 | 30 | min | 73 |
| 5 | 9.0 | 30 | s | 100 |
| 6 | 9.0 | 5 | min | 100 |
| 7 | 9.0 | 10 | min | 100 |
| 8 | 9.0 | 30 | min | 99 |

As can be seen from Table 5, short treatment times (0.5-5 min) practically did not affect the germination. However, longer treatment times (10 min and especially 30 min) resulted in a suppressed germination in the case of unadjusted (acidic) PAA solution.

In the pH-adjusted solution the germination was obviously better than in unadjusted PAA. Even longer treatment times (10 min and 30 min) resulted in practically 100% germination when pH was 9.0. The grains treated at pH=9 were developing faster than those treated with unadjusted PAA.

### Example 6. Antimicrobial Efficiency of PAA at Different pHs

Barley grains were steeped and then treated with PAA at 500 ppm as described in Example 1. Treatment time was 5 s and 30 s, and pH was adjusted with NaOH to 6.5 and 10.0. Results are given in the Table 6.

TABLE 6
Reduction of microbial populations after treatment steeped barley with PAA

| | | APC | | ECC | | YM | |
|---|---|---|---|---|---|---|---|
| Sample | Treatment | | Log₁₀ | | Log₁₀ | | Log₁₀ |
| ID | time, s | Log₁₀ | Reduction | Log₁₀ | Reduction | Log₁₀ | Reduction |
| Control | n/a | 9.07 | n/a | 7.60 | n/a | 3.76 | n/a |
| pH = 6.5 | 5 | 7.34 | 1.73 | 5.94 | 1.66 | 1.30 | 2.46 |
| | 30 | 6.51 | 2.56 | 5.26 | 2.34 | 0.00 | 3.76 |
| pH = 10.0 | 5 | 8.28 | 0.79 | 6.49 | 1.11 | 3.52 | 0.24 |
| | 30 | 7.35 | 1.72 | 5.27 | 2.33 | 3.16 | 0.60 |

As can be seen from the data, the treatment with PAA for 30 s resulted in a better reduction of all microorganisms. However, pH adjustment to pH=10.0 made PAA somewhat less efficient, especially in the case of YM reduction.

### Example 7: Treatment of Barley with Percitric Acid After Steeping and Germination

In this Example, Percitric acid (PCA) was used as a biocide. PCA was synthesized by a reaction of hydrogen peroxide with citric acid. The solution of PCA was then diluted with DI water to the concentration of 500 ppm PCA. To 60 grams of dry barley grains DI water was added at 2:1 ratio. Steeping was performed as described in the Example 1. After the end of the steep time, water was decanted and then 10 grams of the wet grains were treated with 500 ppm PCA solution at 10:1 PAA/grains weight ratio for 30 s at 20° C. Then the PCA solution was decanted and samples of treated and control grains were taken for the micro tests. The rest of the grain was immediately transferred into Petri dishes and placed between two wet paper towels for germination tests. The treated kernels were not washed with water. The germination continued in a water bath at room temperature for 2 days. Then the germinated grains were treated with 500 ppm PCA solution at 10:1 liquid/grains weight ratio for 30 s at 20° C. Then the micro tests were performed on all the samples as described in Example 1. The results of the tests done with APC, ECC, and YM microorganisms are summarized in the Table 7.

TABLE 7
Reduction of microbial populations after treatment of germinated barley with PCA

| | | APC | | ECC | | YM | |
|---|---|---|---|---|---|---|---|
| PCA | Sample | | Log₁₀ | | Log₁₀ | | Log₁₀ |
| Treatment | ID | Log₁₀ | Reduction | Log₁₀ | Reduction | Log₁₀ | Reduction |
| After | Control | 9.14 | n/a | 7.90 | n/a | 5.59 | n/a |
| Steeping | PCA | 7.42 | 1.72 | 4.71 | 3.19 | 4.74 | 0.85 |
| After | Control | 9.21 | n/a | 7.99 | n/a | 5.46 | n/a |
| Germi- | PCA | 7.82 | 1.39 | 6.64 | 1.35 | 5.04 | 0.42 |
| nation | | | | | | | |

PCA was efficient against APC and ECC after both steeping and germination but had a minimal effect on YM. It should be noted that molar mass of PCA is 2.73 times higher than that of PAA, therefore, at 500 ppm there are less peroxyacid groups in PCA. Despite that, the antimicrobial activity of both acids against APC was comparable.

### Example 8: Treatment of Barley with PAA and PCA Before Kilning

In this Example, PAA and PCA were used in 500 ppm solutions. The steeping and germination of barley grains were performed as described in the Example 7. After the end of the germination, the grains were treated with 500 ppm of a peroxyacid solution at 10:1 liquid/grains weight ratio for 30 s at 20° C. Then the micro tests were performed on all the samples as described in Example 1. The rest of the treated and control grains were then placed in an oven for kilning, which was done by drying the treated grains in the oven at 50° C. for 16 hours. Then the temperature was increased to 70° C. and kept for 1 hour; and the final stage was drying for 1 hour at 80° ° C. After the end of kilning, the micro tests were performed on the kilned grains. The results of the tests done with APC, ECC, and YM microorganisms are summarized in the Table 8.

TABLE 8
Reduction of microbial populations after treatment
germinated barley before kilning

| | | APC | | ECC | | YM | |
|---|---|---|---|---|---|---|---|
| | | | Log₁₀ | | Log₁₀ | | Log₁₀ |
| Testing | Treatment | Log₁₀ | Reduction | Log₁₀ | Reduction | Log₁₀ | Reduction |
| After | Control | 8.69 | n/a | 8.26 | n/a | 4.67 | n/a |
| Germi- | PAA, | 7.22 | 1.47 | 6.59 | 1.67 | 0.00* | 4.67* |
| nation | pH = 3 | | | | | | |
| | PAA, | 7.86 | 0.83 | 6.68 | 1.58 | 2.92 | 1.75 |
| | pH = 9 | | | | | | |
| | PCA | 7.73 | 0.96 | 6.69 | 1.57 | 4.41 | 0.26 |
| After | Control | 6.37 | n/a | 3.25 | n/a | 2.00 | n/a |
| Kilning | PAA, | 3.78 | 2.59 | 0.00* | 3.25* | 0.00* | 2.00* |
| | pH = 3 | | | | | | |
| | PAA, | 5.14 | 1.23 | 0.00* | 3.25* | 0.00* | 2.00* |
| | pH = 9 | | | | | | |
| | PCA | 6.05 | 0.32 | 1.54 | 1.35 | 0.00* | 2.00* |

*complete kill

Efficiency of PAA and PCA against APC measured after germination was moderate but increased after the treated grains were kilned. In the case of ECC and YM the biocidal effect of peroxyacids was more noticeable. The treatment resulted in complete kill of yeast and mold in the kilned grains. Unadjusted PAA caused a complete kill of ECC microorganisms when treated after germination.

The results of the experiments in Examples 1-8 show that the antimicrobial treatment with peroxyacids could be performed after steep and/or germination stage of the malting process.

### Example 9. Treatment of Fusarium with PAA: Time Kill Study

Fusarium graminearum 46779 was used as a straight culture. It was plated on potato dextrose agar and grown at room temperature in the dark for 4 days (series 1) and 5 days (series 2). Plates were then rinsed with sterile DI water and spun down at 3000 rpm for 10 min. To get the final titer, the serial dilution in Butterfield's buffer was performed, the samples were plated on Petrifilm Yeast and Mold Count Plate (3M™ Microbiology) and incubated for 3 days at 25° C.

Peracetic acid PAA 15/10 (PeroxyChem, no catalyst added) was diluted to concentrations specified in Table 9 below. Then 9 ml of PAA solution was added to a sterile centrifuge tube, and 1 mL inoculum was added. After the treatment, residual PAA was neutralized by adding 1 mL of sample to neutralization tube containing 0.5% Sodium Thiosulfate in 9 mL Letheen broth. Tubes were sonicated for 5 minutes, vortexed for 30 seconds, and then serial dilution was performed. Then the samples were plated on 3M Petrifilm Yeast and Mold Count Plates and incubated at 25° C. for 5 days. Every test was performed in duplicate. The results for series 1 are shown in the Table 9.

TABLE 9
Treatment of Fusarium with PAA solutions
at various concentration and time.

| | | | Average |
|---|---|---|---|
| | | C*t | Log₁₀ |
| PAA, ppm | Time, s | (ppm × min) | Reduction |
| 0 | 60 | 0 | 0 |
| 50 | 15 | 12.5 | 0.25 |
| | 30 | 25 | 0.59 |
| | 60 | 50 | 0.88 |
| 125 | 15 | 31.25 | 0.99 |
| | 30 | 62.5 | 2.56 |
| | 60 | 125 | 3.89 |
| 250 | 15 | 62.5 | 3.67 |
| | 30 | 125 | 4.41 |
| | 60 | 250 | 5.71* |
| 500 | 15 | 125 | 5.71* |
| | 30 | 250 | 5.71* |
| | 60 | 500 | 5.71* |

*Complete kill

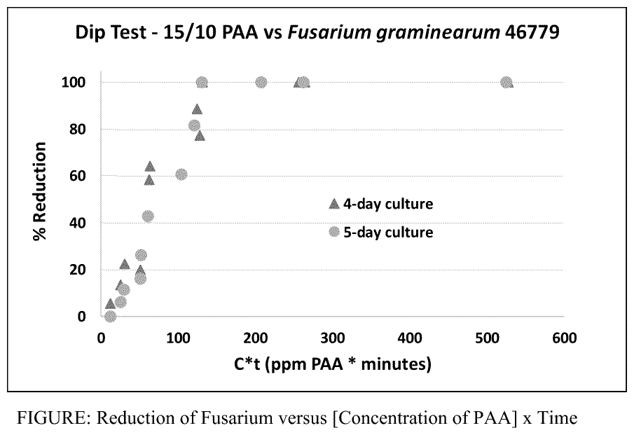

The results show that a complete kill of Fusarium can be achieved with PAA given enough time and a sufficient concentration. The results are presented in FIG. 1 as Log₁₀ reduction versus C*t.

### REFERENCES

1. U.S. Pat. No. 6,927,192. Process to improve the quality of grains and seeds.
2. US 2016/0044940 A1. Method of treating grains and treated grains.
3. Kunz, T. and Methner, F.-J., The cleaning effect on brewing barley using vibrations during wet steeping. BrewingScience 2015, Vol. 68, pp. 29-37.
4. J. W. Green and M. J. Sanger, EFFECT OF HYDROGEN PEROXIDE AND OF PERACETIC ACID IN MALTHOUSE STEEP LIQUOR. J. Inst. Brew., Vol. 62, 1956, pp. 170-179.
5. Rood, L., Koutoulis, A., et al. Control of microbes on barley grains using peroxyacetic acid and electrolyzed water as antimicrobial agents. Food Microbiology, 76 (2018) pp. 103-109.
6. U.S. Pat. No. 9,622,495. Methods to decontaminate cereal grains with Chlorine Dioxide.
7. Van Nierop, S. N., et al. The impact of microorganisms on barley and malt quality—A review. Journal of the American Society of Brewing Chemists, 2006; 62(2); pp. 69-79.
8. Dodd, G. J., et al. Effect of Ozone Treatment on the Safety and Quality of Malting Barley. Journal of Food Protection, Vol. 74, No. 12, 2011, Pages 2134-2141.

All references cited herein are fully incorporated by reference. Having now fully described the invention, it will be understood by one of skill in the art that the invention may be performed within a wide and equivalent range of conditions, parameters and the like, without affecting the spirit or scope of the invention or any embodiment thereof.

1. A method of treating harvested grain or seeds to reduce the presence of harmful microorganisms during a malting procedure, the method comprising:
performing a decontamination by contacting the grain or seeds with a sanitizing solution comprising a peroxyacid and hydrogen peroxide, wherein:
a) said malting procedure comprises sequentially performing a steeping, a germination and a kilning;
b) said sanitizing solution comprises 250-5000 ppm of the peroxyacid;
c) contact between the grains or seeds and the sanitizing solution is maintained for a period sufficient to reduce a total microbial count (APC) of the grains or seeds and/or a yeast and mold count (YM) by at least 90% compared to the same grains or seeds prior to contact with the sanitizing solution;
d) the grains or seeds are contacted with the sanitizing solution after steeping but before germination; and/or after germination but before kilning; and/or after kilning;
and wherein the grains or seeds are not contacted with the sanitizing solution prior to steeping.

2. The method of claim 1, wherein, after contacting the grain or seeds with the sanitizing solution, the seeds or grains are washed to remove the sanitizing solution and/or the sanitizing solution is treated with a reducing agent to neutralize the hydrogen peroxide.

3. The method of claim 1, wherein the decontamination of the grains or seeds is carried out at a pH below 7.

4. The method of claim 3, wherein contact between the grains or seeds and the sanitizing solution does not last more than 10 minutes.

5. The method of claim 1, wherein the decontamination of the grains or seeds is carried out at a pH of 7 or higher.

6. The method of claim 5, wherein contact between the grains or seeds and the sanitizing solution does not last more than 60 minutes.

7. The method of claim 1, wherein the sanitizing solution has a peroxyacid to peroxide ratio in a range of 5.0 to 0.2.

8. The method of claim 1, wherein the grain or seeds are at least one selected from the group consisting of barley, wheat, rye, millet, corn (maize), rice, and oats.

9. The method of claim 1, wherein the sanitizing solution is applied by washing or spraying the grains or seeds.

10. The method of claim 1, wherein an amount of the sanitizing solution used for contacting the grain or seeds is 0.05 liters to 5.0 liters per kilogram of dry grain.

11. The method of claim 1, wherein the peroxyacid used in decontaminating the grain or seeds is selected from the group consisting of: peracetic acid, percitric acid, perlactic acid, perpropionic acid, peroxalic acid, permalic acid, permalonic acid, persuccinic acid, perglutaric acid, peradipic acid, permaleic acid, perfumaric acid, and mixtures thereof.

12. The method of claim 1, wherein microorganisms in the grain or seeds that are reduced as a result of the decontamination comprise at least one mold, yeast, bacterium, or fungus.

13. The method of claim 1, wherein, in addition to contacting the grains or seeds with the sanitizing solution after steeping but before germination; and/or after germination but before kilning; and/or after kilning; the grains or seeds are germinated, at least in part, in the presence of a sanitizing solution comprising a peroxyacid and hydrogen peroxide.

14. The method of claim 13, wherein germination comprises maintaining the grains or seeds in a moist environment while in contact with the sanitizing solution.

15. The method of claim 13, wherein germination comprises soaking the grains or seeds in the sanitizing solution, wrapping the grains or seeds in a material soaked in the sanitizing solution, or exposing the seeds to a mist of the sanitizing solution.

16. The method of claim 1, wherein, in addition to contacting the grains or seeds with the sanitizing solution after steeping but before germination; and/or after germination but before kilning; and/or after kilning; the grains or seeds are contacted with the sanitizing solution during at least part of the kilning process.

17. The method of claim 16, wherein the sanitizing solution is applied to the grains or seeds within one minute of the start of kilning.

18. The method according to claim 3, wherein the decontamination of the grains or seeds is carried out at a pH of 3-5.

19. The method according to claim 5, wherein the decontamination of the grains or seeds is carried out at a pH of 8-11.
